(19) United States
(12) Patent Application Publication
(10) Pub. No.: US 2014/0047127 A1
(43) Pub. Date: Feb. 13, 2014

(54) COORDINATED ENFORCEMENT OF TRAFFIC SHAPING LIMITS IN A NETWORK SYSTEM

(71) Applicant: INTERNATIONAL BUSINESS MACHINES CORPORATION, Armonk, NY (US)

(72) Inventors: Robert David Callaway, Holly Springs, NC (US); Adolfo Francisco Rodriguez, Raleigh, NC (US); Ioannis Viniotis, Cary, NC (US)

(73) Assignee: INTERNATIONAL BUSINESS MACHINES CORPORATION, Armonk, NY (US)

(21) Appl. No.: 13/781,733

(22) Filed: Feb. 28, 2013

Related U.S. Application Data
(63) Continuation of application No. 13/571,349, filed on Aug. 10, 2012.

(51) Int. Cl. H04L 12/70

(52) U.S. Cl. CPC H04L 47/10
USPC 709/235

(57) ABSTRACT

Methods and protocols coordinate enforcement of application traffic shaping limits within clusters of middleware appliance information handling systems (MA IHSs). The protocols dynamically set the local traffic shaping requirements at each entry point of an MA IHS. Each MA IHS receives from other MA IHSs runtime statistics containing local shaping requirements and rates of requests. The method uses runtime statistics to measure performance against specified traffic shaping goals, and based on this comparison uses unique protocols to dynamically adjust the local shaping requirements in each MA IHS. The method may eliminate the need to statistically bind service domains to particular MA IHSs. Additional MA IHSs activate and/or deactivate service domains to accommodate service domain (server farm) CPU resource demands.

### CROSS REFERENCE TO RELATED PATENT APPLICATIONS

This patent application is a continuation of, and claims priority to, the U.S. Patent Application entitled “Coordinated Enforcement Of Traffic Shaping Limits In A Network System”, inventors Callaway, et al., Ser. No. 13/571,349, filed Aug. 10, 2012, that is assigned to the same Assignee as the subject patent application, the disclosure of which is incorporated herein by reference in its entirety.

### BACKGROUND

The disclosures herein relate generally to networked information handling systems (IHSs), and more particularly, to controlling traffic flow to a group of networked IHSs.

### BRIEF SUMMARY

In one embodiment, a method of servicing requests is disclosed wherein middleware appliance (MA) information handling systems (IHSs) receive requests from service client IHSs for forwarding to a service domain. More particularly, the method includes receiving service requests by a plurality of middleware appliance information handling systems (MA IHSs) that communicate with a service domain, thus providing received service requests. Each MA IHS includes an entry point. The method also includes forwarding the received service requests, by the plurality of MA IHSs, to the service domain for handling. Each MA IHS includes a service level management component that forwards requests to the service domain based on a respective initial local traffic shaping rate goal. The method further includes determining, by the service level management component in each MA IHS, a traffic shaping rate and an actual traffic rate for each MA IHS. The method still further includes exchanging, by the service level management component in each MA IHS, the traffic shaping rate and actual traffic rate of each MA IHS with the service level management components of the other MA IHSs, thus providing exchanged run time statistics. The method also includes determining, by the service level management component of each MA IHS, compliance with the initial traffic shaping rate goal of each MA IHS based on the traffic shaping rates and actual traffic rates of the exchanged run time statistics, thus providing respective compliance determinations. The method further includes dynamically adjusting, by the service level management component of each MA IHS, the traffic shaping rate of each MA IHS in response to respective compliance determinations for each MA IHS.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed enterprise network.

FIG. 2 is a block diagram of a representative middleware appliance IHS.

FIG. 3 is a flowchart that depicts operation of one embodiment of the disclosed middleware appliance IHS of the enterprise network.

FIG. 4 is a flowchart that depicts the detailed operation of one embodiment of the disclosed middleware appliance IHS of the enterprise network.

### DETAILED DESCRIPTION

Service level management involves managing the parts of a network system to a predetermined level of expected and contracted service and performance. In one embodiment, a client service contract (CSC), such as a traffic shaping contract, may govern the respective traffic rates at which service client information handling systems (IHSs) access a service domain. Multiple middleware appliance IHSs (MA IHSs) couple service client IHSs to a service domain, such as a server farm, to regulate traffic flow from the service client IHSs to the service domain. The service client IHSs may access multiple entry points to clusters of MA IHSs via a wide area network such as the Internet or via another communication network. The CSC may specify a traffic shaping rate that limits the rate at which the MA IHSs forward requests from a particular service client IHS or group of service client IHSs to the service domain. In this manner, the MA IHSs may limit the actual traffic rate of service per service client IHS to satisfy the CSC. The CSC may specify a traffic shaping rate for each service client IHS. This traffic shaping rate is a target traffic rate for a particular service client IHS or group of service client IHSs. MA IHSs may measure the respective actual traffic rates that their entry points provide. Each MA IHS may also broadcast to all other MA IHSs the values of the actual traffic rates and traffic shaping rates for a measurement/enforcement period. A service level management component, i.e. tool, in the MA IHS controls the traffic shaping rates that the MA IHS enforces.

After exchanging the actual traffic rates from all other MA IHSs, each MA IHS may update its local traffic shaping rate to an updated local traffic shaping rate. The term “local” refers to a particular MA IHS. The term “global” refers to multiple MA IHSs. One way that a MA IHS may update its local traffic shaping rate is to determine the actual global traffic rate which is the traffic rate that the MA IHS achieves from the time of beginning of a current measurement/enforcement period and to determine the global traffic rate that the MA IHS achieved during a previous subinterval. Each MA IHS may then determine a respective updated target traffic shaping rate, i.e the target traffic rate, which that MA IHS may use during the next measurement/enforcement period. Each MA IHS may set its local shaping rate to its own updated local shaping rate and may send that amount of traffic to the service domain during the next measurement/enforcement period. Traffic may take the form of bytes, packets or messages. In one embodiment, the MA IHSs may operate on traffic messages to control the routing of traffic messages to the service domain. To transmit a message (i.e. some entity containing information of interest) over a networked communication medium, it may be required to split the message into smaller segments, and transmit each of those segments as the payload portion of one or more packets, each of which may contain one or more bytes.

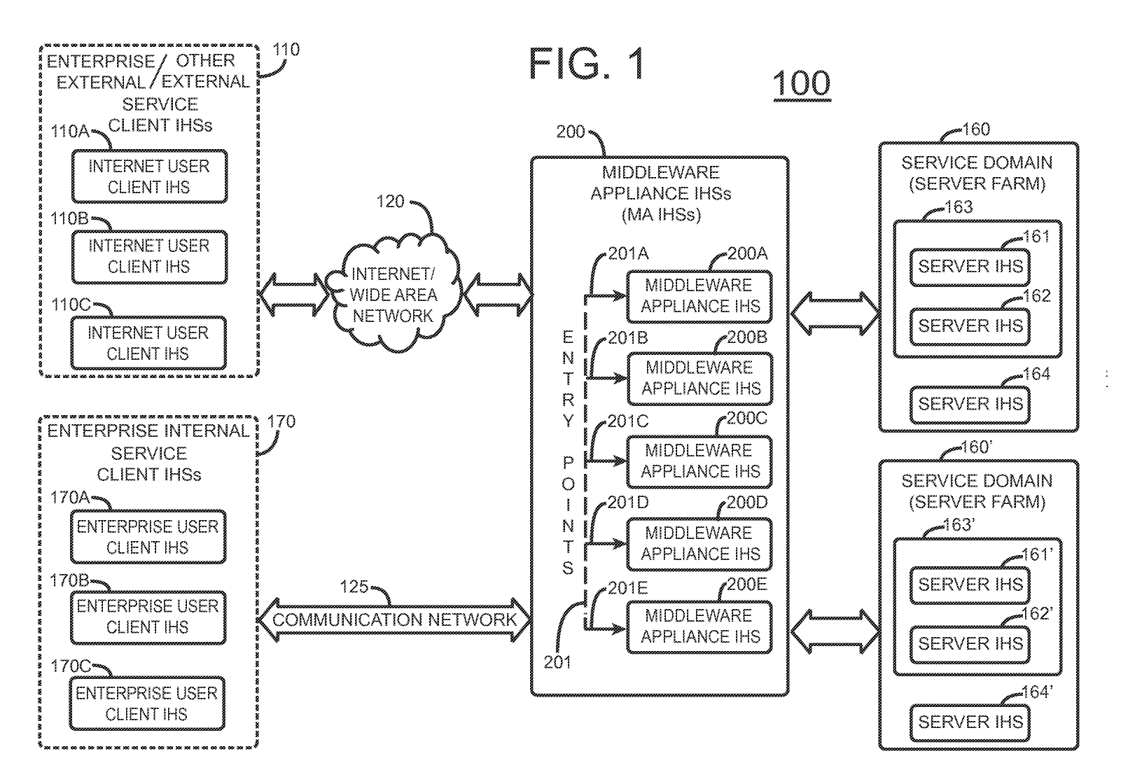

FIG. 1 is a block diagram of the disclosed enterprise network 100 that may include multiple external service client IHSs 110, a wide area network 120, multiple entry points 201, multiple middleware appliance information handling systems (MA IHSs) 200 and service domains such as service domain 160 and service domain 160′. The multiple MA IHSs together form a MA IHS cluster that may be called MA IHS cluster 200. Service domain 160 and server domain 160′ may be backend systems that includes multiple server IHSs such as mainframe IHSs, minicomputer IHSs and other IHSs. If requests for service from client IHSs require more service resources such CPU time, then the MA IHSs 200 may activate additional service domains such as service domain 160′.

Middleware appliance IHSs 200 serve as proxies for processing requests that target service domain 160. Enterprise network 100 may also include one or more internal service client IHSs 170 exemplified by enterprise user client IHS 170A. Enterprise user client IHS 170A may access the multiple entry points 201 of MA IHSs 200 directly via communication network 125, that is, without traversing the wide area network 120. Client service contracts (CSCs) govern the rate at which external service client IHSs 110 and internal service client IHSs 170 may access service domain 160. Internal service client IHSs refer to IHSs within a business entity or other organizational entity, i.e. those service client IHSs that connect via the entity's own communication network 125. These internal service client IHSs are enterprise internal service client IHSs 170 as shown in FIG. 1. Internal service client IHSs 170 connected by communications network 125 may physically reside in the same facility as the MA IHSs 200, or they may reside at a remote location such as in another city, state or country. In one embodiment, external service client IHSs do not access MA IHSs 200 via communication network 125. External service client IHSs are service client IHSs that are external to the business entity or other organizational entity, and that couple to service domain 160 by a network other than communication network 125. These external client IHSs may couple to service domain 160 via a wide area network such as the Internet 120. These external service client IHSs are enterprise external service client IHSs 110 as shown in FIG. 1.

Service domain 160 may include clusters of server IHSs that work with one another to process requests. For example, service domain 160 may include a service domain cluster 163 that may include server IHSs 161 and 162. Service domain 160 may also include server IHS 164. Service domain 160′ may include clusters of server IHSs that work together with one another to process requests. For example, service domain 160′ may include a service domain cluster 163′ that may include server IHSs 161′ and 162′. Service domain 160′ may also include server IHS 164′.

The multiple entry points 201 of MA IHSs 200 may include entry point 201A, 201B, 201C, 201D and 201E. The service client IHSs may include Internet user client IHS 110A, 110B and 110C. MA IHSs 200 may include MA IHSs 200A, 200B, 200C, 200D and 200E. MA IHSs 200A, 200B, 200C, 200D and 200E may respectively include entry points 201A, 201B, 201C, 201D and 201E, as shown in FIG. 1. MA IHSs 200 may interconnect with each other by wire or wirelessly as described below. In one embodiment, if one of MA IHSs 200A, 200B, 200C, 200D and 200E fails, another one of MA IHSs 200A, 200B, 200C, 200D and 200E may take over for the failed MA IHS. Internal service client IHSs 170 may include enterprise user client IHSs 170A, 170B and 170C. External service client IHSs 110 may include enterprise external service client IHSs 110, 110B and 110C.

In enterprise network 100, the web server farm, for example service domain 160, may host multiple service providers, for example server IHSs 161, 162, and 164. A client service contract (CSC) may govern the traffic rate at which a service client (for example internet user client IHS 110A of service client IHSs 110) may access service domain 160 so that a particular service client does not unduly overwhelm an server IHS. The CSC may protect a service resource such as CPU time. “Traffic shaping” limits the amount of CPU time that a client IHS may consume in the web server farm that service domain 160 forms. The CSC, for example, may define the traffic shaping requirement with two parameters, X and T, as follows: “Limit the traffic rate to a service provider, such as server IHS 161 for example, to no more than X=100 units per second”, with an “measurement/enforcement” time period of T=2 seconds. These units may specify a number of service requests and/or XML documents, or messages or other estimates of CPU time consumption. Service client IHSs 110 may access services in service domain 160 from multiple entry points 201. The disclosed traffic shaping methodology may involve multiple security zones, and/or performance goals, that employ multiple entry points 201 such as entry points 201A, 201B, 201C, 201D, and 201E. The disclosed traffic shaping methodology may include the activation of additional server IHSs or deactivation of server IHSs in service domain 160, as discussed in more detail below.

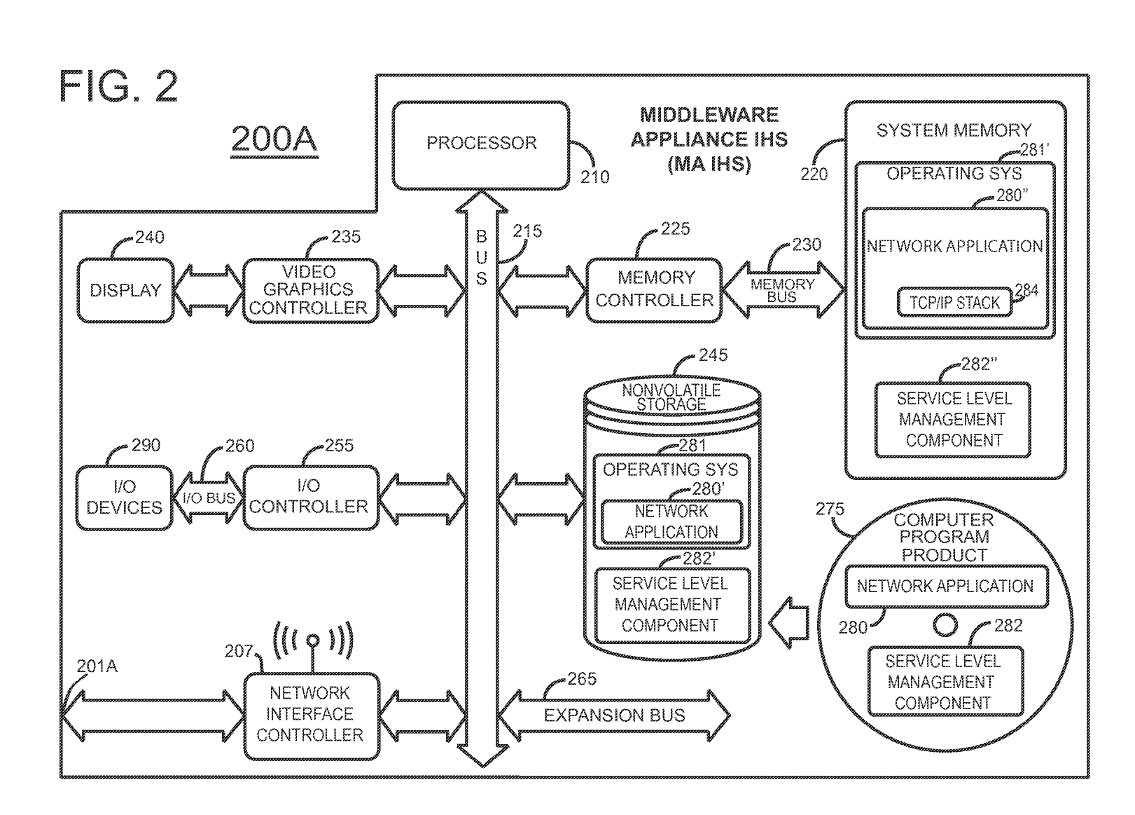

FIG. 2 is a block diagram of a MA IHS 200A that enterprise network 100 may employ as a MA IHS 200A for shaping traffic from multiple entry points 201 to service domains 160. MA IHS 200A includes a processor 210 that may include multiple cores. MA IHS 200A processes, transfers, communicates, modifies, stores or otherwise handles information in digital form, analog form or other form. MA IHS 200A includes a bus 215 that couples processor 210 to system memory 220 via a memory controller 225 and memory bus 230. In one embodiment, system memory 220 is external to processor 210. System memory 220 may be a static random access memory (SRAM) array and/or a dynamic random access memory (DRAM) array. A video graphics controller 235 couples display 240 to bus 215. Nonvolatile storage 245, such as a hard disk drive, CD drive, DVD drive, or other nonvolatile storage couples to bus 215 to provide MA IHS 200A with permanent storage of information. I/O devices 290, such as a keyboard and a mouse pointing device, couple to bus 215 via I/O controller 255 and I/O bus 260. One or more expansion busses 265, such as USB, IEEE 1394 bus, ATA, SATA, PCI, PCIE, DVI, HDMI and other expansion busses, couple to bus 215 to facilitate the connection of peripherals and devices to MA IHS 200A.

MA IHS 200A includes a network interface controller 207 that couples to bus 215 to enable MA IHS 200A to connect by wire or wirelessly to a network such as wide area network 120, communication network 125 or to other MA IHSs 200, via entry point 201A of multiple entry points 201. MA IHS 200A may take the form of a desktop, server, portable, laptop, notebook, or other form factor computer or data processing system. MA IHS 200A may take other form factors such as a portable telephone device, a communication device or other devices that include a processor and memory.

MA IHS 200A may include a computer program product on digital media 275 such as a CD, DVD or other media. In one embodiment, digital media 275 includes a service level management component 282 and a network application 280 on computer program product 275, that correspond to network application 280′ and service level management component 282′, respectively, on nonvolatile storage 245. Nonvolatile storage 245 may store network application 280′ as part of operating system 281, as shown in FIG. 2. When MA IHS 200A initializes, MA IHS 200A loads operating system 281 (including network application 280′) and service level management component 282′ into system memory 220 for execution as operating system 281′, network application 280″ which may include TCP/IP stack 284, and further loads service level management component 282′ into system memory 220′. Operating system 281′, which may include network application 280″, governs the operation of MA IHS 200A. In an alternative embodiment, service level management component 282″ may be an application that is separate and distinct from operating system 281′. Network application 280″ may include a browser and may also include an e-mail function. Network application 280″ may also include file transfer protocol (FTP) functions and may include additional communications protocols and functions. In an alternative embodiment, network application 280″ may be an application that is separate and distinct from operating system 281′.

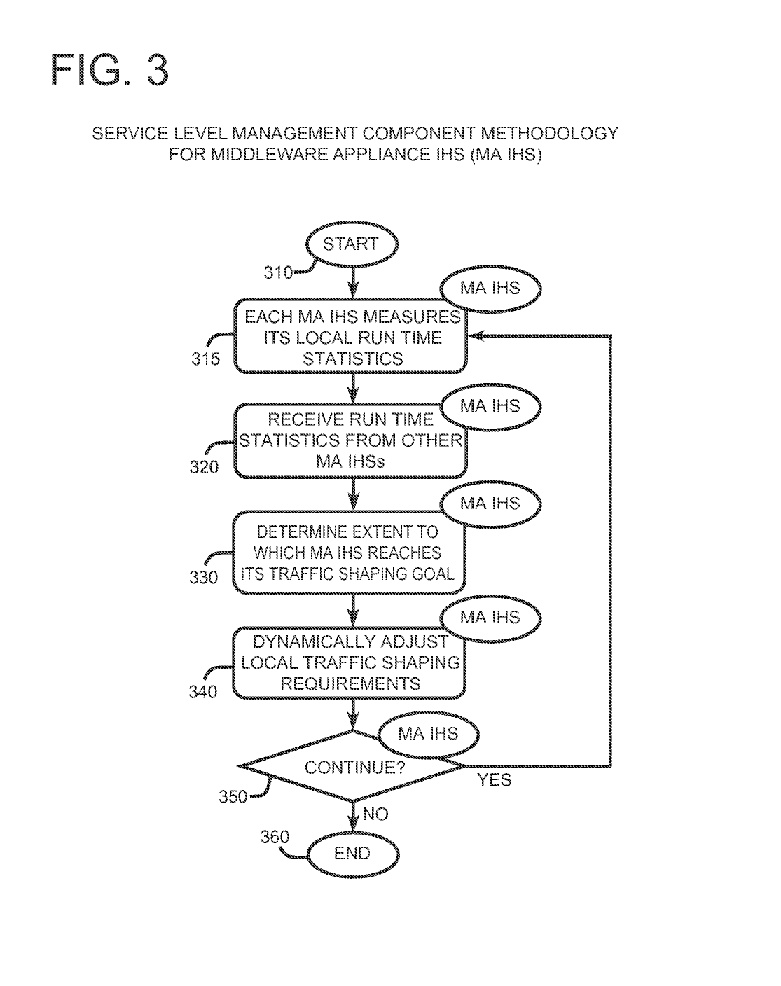

FIG. 3 is a flowchart that shows a high level description of the operation of service level management component 282″ in a representative MA IHS 200A in enterprise network 100. Service level management component 282″ acts as a tool that enforces CSCs and may improve performance of enterprise network 200 while enforcing the CSCs. Operation commences with start block 310. Each MA IHS 200, for example MA IHS 200A, measures its own local run time statistics, as per block 315. The term “local” as used herein refers to a quality that a particular structure exhibits, as opposed to a quality exhibited by a structure that is distant from the particular structure. For example, local run time statistics of MA IHS 200A refer to the run time statistics that MA IHS 200A exhibits. Each MA IHS 200, for example MA IHS 200A, receives run time statistics from every other MA IHS 200, for example MA IHSs 200B, 200C, 200D and 200E, as per block 320. Run time statistics may include a count of messages intended for a particular service domain. The CSC may define and enforce message traffic counts to the particular service domain. The count of messages may include messages that the particular service domain accepts and/or messages that the particular service domain rejects.

Each MA IHS 200 processes the run time statistics that such MA IHS receives from every other MA IHS 200 to determine how well each MA IHS 200 meets its traffic shaping goals, such as its target traffic shaping rate, as per block 330. In this manner, each MA IHS 200, for example MA IHS 200A, provides respective local traffic statistics. These local traffic statistics are local run time statistics that may include an enumeration of message traffic rates that each MA IHS 200 handles. Each particular MA IHS dynamically adjusts its local traffic shaping requirements based on the run time statistics that the particular MA IHS receives from all other MA IHSs, as per block 340. In one embodiment, for as long as MA IHS 200 remains in service, a countdown timer (not shown) counts down to the next measurement subinterval, as per decision block 350, and transfers control back to block 315. More particularly, the service level management component 282″ performs a test to determine if the method should continue, as per decision block 350. If service should continue because MA IHS 200 is still in service, then process flow continues to block 315. Otherwise, operation of the MA IHS 200, for example MA IHS 200A terminates with end block 360.

The service level management component 282″ in each MA IHS 200 may operate as follows, using the definitions:
T=the measurement/enforcement period (i.e. time interval), expressed in seconds;
k=subinterval of time interval T, expressed in seconds;
K=the numbers of subintervals subdividing measurement/enforcement period T;
N=the number (for example N=5 for MA IHSs 200A, 200B, 200C, 200D, 200E) of MA IHSs 200;
X=the traffic shaping rate to a service provider (for example to service domain 160).
   A global Customer Service Contract (CSC), that is, “global” across all MA IHSs 200, applicable to service client IHS 110 may define the global traffic shaping requirement with two parameters, X and T, as follows:
Limit the traffic rate to a service provider, for example to service domain 160, to no more than X units per second”, with a measurement/enforcement interval period of T seconds.
   Consequently, the MA IHSs 200A, 200B, . . . 200E of MA IHS cluster 200 may collectively send X*T (that is, X multiplied by T) units of traffic to the service provider in service domain 160 for each interval of T seconds. Any measurement/enforcement period of T seconds, wherein the service provider receives no more than X*T units from the MA IHSs, satisfies the shaping requirement of the CSC. In one embodiment, an acceptable traffic shaping goal for the service level management component 282″ of a MA IHS 200 is to send as close to X*T traffic units as possible to a service domain. In this manner, service level management component 282″ of a MA IHS 200 regulates its traffic rate to a particular service domain.

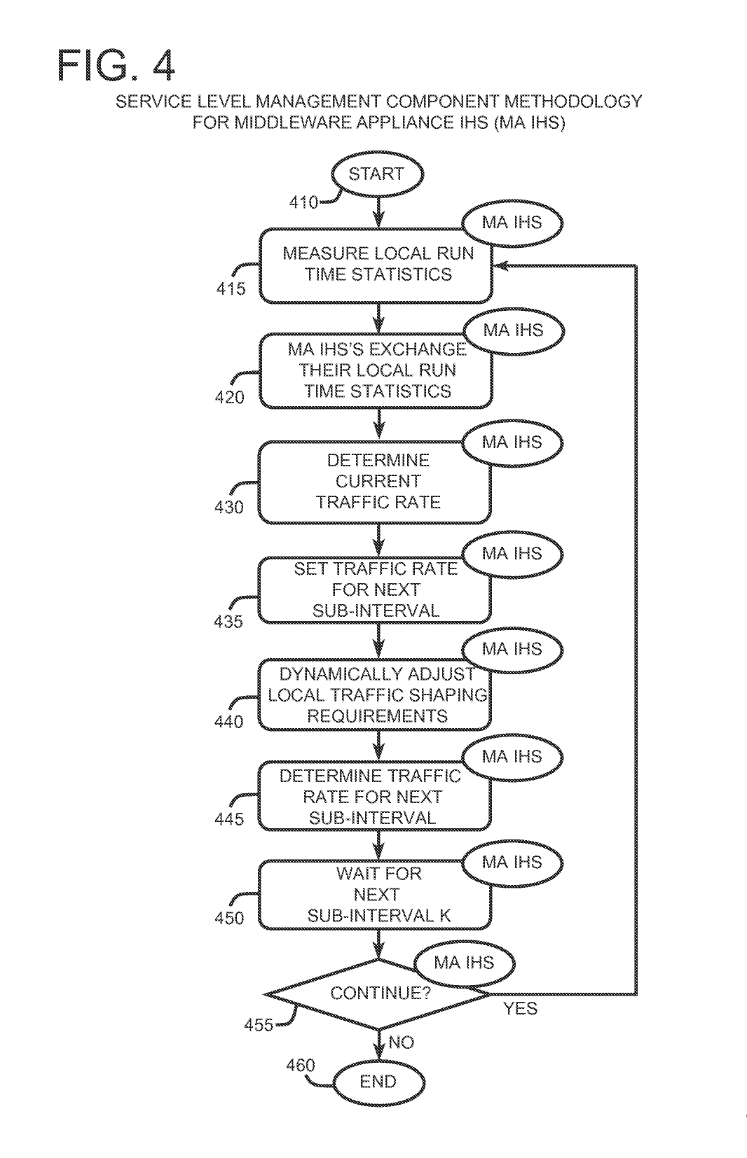

FIG. 4 is a flowchart that shows a more detailed description of the operation of one embodiment of the service level management component 282″ in MA IHS 200 in enterprise network 100. Operation commences with start block 410. An initial configuration at each MA IHS 200 specifies X, N, T, K. (for example the number of subintervals K=10).

Each MA IHS 200, for example MA IHS 200A, measures its own local run time statistics as per block 415. At the beginning of subinterval k (T/K such subintervals make up a measurement/enforcement period of T seconds) each of the j=1, 2, . . . , N MA IHSs 200 (for example j=1 may represent MA IHS 200A, j=2 may represent MA IHS 200B, and so forth), determines a traffic shaping rate xj(k) that the service level management component 282″ enforces during the measurement subinterval k. EQUATION 1 below is an equation that service level management component 282 may employ to determine the initial traffic shaping rate xj(k) to apply to the traffic that the service level management component monitors and controls. In one embodiment, the initial traffic shaping rate spreads evenly across each of the N MA IHSs, wherein N is the total number of deployed MA IHSs in the MA IHS cluster 200. In this scenario, the initial traffic shaping rate xj(k) at each MA IHS may be X/N for an initial interval.

traffic shaping rate xj(k)=X/N EQUATION 1

The service level management component 282 of each particular MA IHS applies the traffic shaping rate xj(k) to the traffic passing through that particular MA IHS. The traffic shaping rate xj(k) acts as an upper bound to the amount of traffic that the service level management component 282 allow to pass from the entry point of the MA IHS to the output of the MA IHS which forwards that traffic to the service domain 160. For example, the service level management component 282 of a MA IHS 200A uses EQUATION 1 to determine the initial traffic shaping rate xj(k) for MA IHS 200A. The MA IHS 200A regulates the flow of traffic from its entry point 201A to the output of MA IHS 200A such that the actual traffic rate that MA IHS 200A supplies to service domain 160 does not exceed xj(k).

The service level management component 282 in each MA IHS 200, for example MA IHS 200A, measures the actual traffic rate rj(k) that it supplies output from the traffic it receives at its entry point 201, for example from entry point 201A of MA IHS 200A. If insufficient traffic enters a MA IHS 200, i.e. if traffic less than the traffic shaping rate xj(k) enters that MA IHS 200, then the actual traffic rate rj(k) may be less than the traffic shaping rate xj(k) that the service level management component 282 enforces. Otherwise, rj(k) may equal xj(k). At the end of each subinterval k, each MA IHS knows the traffic shaping rate xj(k) which that particular MA IHS enforced during the subinterval k. At the end of each subinterval k, each MA IHS also knows the actual traffic rate which that the particular MA IHS achieved during that subinterval k.

Each MA IHS 200, for example MA IHS 200A, receives run time statistics from every other MA IHS 200, for example from MA IHSs 200B, 200C, 200D and 200E as per block 420. These run time statistics include the values of the traffic shaping rate xj(k) and the actual traffic rate rj(k) at the end of a subinterval. In response to completion of a subinterval, a particular MA IHS 200 broadcasts its traffic shaping rate xj(k) and its actual traffic rate rj(k), i.e. its run time statistics, to the other MA IHSs in MA IHS cluster 200. In other words, in one embodiment, each MA IHS 200 broadcasts to all other MA IHSs 200 the values rj(k) and xj(k) at the end of a measurement subinterval.

Each MA IHS 200 processes the run time statistics from every other MA IHS 200 to determine how well each MA IHS 200 meets its traffic shaping requirement goals, as per block 430. In other words, each MA IHS determines its respective degree of compliance with the traffic shaping requirement goal for that MA IHS. After receiving run time statistics from all other MA IHSs 200, each of the j individual MA IHSs 200 may update its local shaping rate xj(k) in the following manner:

Service level management component 282″ determines r(k), the actual global traffic rate during the last subinterval, as per EQUATION 2 below:

r(k)=sum{j=1 to N} rj(k) EQUATION 2

Service level management component 282″ also determines R(k), the actually achieved global traffic rate since the beginning of the current measurement/enforcement period, as per EQUATION 3 below:

R(k)=1/k sum{n=1 to k} r(n) EQUATION 3

Service level management component 282″ also determines xj(k), the target traffic shaping rate that the service level management component 282″ will use during the next measurement/enforcement period as follows:

If R(k)>X, then the particular MA IHS 200 sent more traffic to the service provider (for example, to the service domain 160), than the CSC allows, indicating that the service level management component 282″ of a particular MA IHS 200 should lower its traffic shaping rate, xj(k) to conform more closely with the CSC. In this scenario, service level management component 282″ in the particular MA IHS 200 determines excess/deficit parameter D. The value D signifies whether a particular MA IHS 200 sent too little or too much traffic to the service domain 160 in view of the traffics shaping goals that the CSC specifies. In this manner, each MA IHS 200 determines how well each MA IHS 200 meets its traffic shaping goals. More particularly, service level management component 282 determines D according to EQUATION 4 below:

let D=X−R(k) EQUATION 4
wherein D is a negative number.
   Alternatively, if R(k)<X, then the particular MA IHS 200 sent less traffic to the service provider (for example, to the service domain 160), than the CSC allows, indicating that service level management component 282″ in the particular MA IHS 200 needs to increase its traffic shaping rate, xj(k). In this scenario, service level management component 282″ in the particular MA IHS 200 determines D according to EQUATION 5 below:

D=X−R(k) EQUATION 5
wherein D is a positive number

Each MA IHS 200 sets the rate for the next measurement subinterval, k, as per EQUATION 6 below which corresponds to block 435:

Set xj(k+1)=xj(k)+D/N. EQUATION 6

In one embodiment of the disclosed method, a traffic rate allocation process allocates the deficit/excess rate D in proportion to xj(k). Each service level management component 282″ in a particular MA IHS 200 dynamically adjusts local traffic shaping requirements based on the run time statistics that such service level management component 282″ receives from all other MA IHSs 200, as per block 440. In one embodiment, each j-th MA IHS 200 sets its local shaping rate to xj(k), and sends no more than xj(k) units of traffic per second during subinterval k.

One exemplary traffic shaping method may provide multiple variations of traffic shaping by determining how to allocate: DXj(k, D, j, {xj(k), rj(k)}); the deficit/excess rate D to the j-th MA IHS 200. More particularly, the traffic rate allocation may be a function of k, D, j, xj(k), and rj(k). The traffic rate allocation may further depend on k, the index of the subinterval. The traffic rate allocation may also depend on the magnitude of the excess/deficit parameter D. Large values of D, for example, may call for more aggressive traffic rate allocations. Smaller values of D may call for no action. The traffic rate allocation may also depend on the index j of a particular MA IHS 200, or on {xj(k), j=1, . . . , N}, the current shaping rate at all of the MA IHSs 200, or on {rj(k), j=1, . . . , N}, the current actual rate at all of the MA IHSs 200. For example, if rj(k) is less than xj(k), the traffic shaping method may specify a more aggressive traffic rate allocation at the j-th MA IHS 200. In one embodiment, a traffic shaping algorithm in the service level management component 282″ may set DXj(k, D, j, {xj(k), rj(k)})=D/N and may ignore, for simplicity, all parameters except the magnitude of the excess/deficit parameter D.

Each MA IHS 200 recalculates its respective traffic shaping rate for next subinterval k, as per block 445. The MA IHS 200 waits for the next subinterval k, as per block 450. For as long as MA IHS 200 remains in service the process continues, as per block 455, with transfer of control back to block 415. Otherwise operation of the MA IHS 200 terminates with end block 460.

In this manner, a particular client does not overwhelm a service domain 160. In one embodiment, the disclosed methodology may provide improved performance in comparison with manual, static allocation (MSA) of global traffic shaping requirements to multiple entry points. In one embodiment, the disclosed methodology may provide arbitrary allocation of traffic shaping requirements to an entry point appliance such as a middleware appliance IHS (MA IHS) to satisfy a client service contract (CSC) in a distributed manner. Moreover, the disclosed methodology may adjust to time-varying, random workloads. Additional MA IHSs activate and/or deactivate service domains to achieve service domain (server farm) CPU resource demands. Network 100 may activate/deactivate service domains to more effectively utilize the underlying capacity of service domain resources. Network 100 needs additional service domain physical resources such as power and cooling only when additional service domains become active. When network 100 deactivates a service domain, network 100 no longer requires those resources for the now deactivated service domain and thus may conserve energy. In one embodiment, the disclosed methodology may adjust for a failed server IHS by reallocating traffic to remaining server IHSs in a service domain.

As will be appreciated by one skilled in the art, aspects of the disclosed methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the FIGS. 3 and 4 flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts of FIGS. 3 and 4 and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowcharts of FIGS. 3 and 4 described above.

The flowcharts of FIGS. 3 and 4 illustrate the architecture, functionality, and operation of possible implementations of systems, methods and computer program products that perform network analysis in accordance with various embodiments of the present invention. In this regard, each block in the flowcharts of FIGS. 3 and 4 may represent a module, segment, or portion of code, which comprises one or more executable instructions for implementing the specified logical function(s). It should also be noted that, in some alternative implementations, the functions noted in the block may occur out of the order noted in FIGS. 3 and 4. For example, two blocks shown in succession may, in fact, be executed substantially concurrently, or the blocks may sometimes be executed in the reverse order, depending upon the functionality involved. It will also be noted that each block of FIGS. 3 and 4 and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, blocks, operations, elements, and/or components, but do not preclude the presence or addition of one or more other features, integers, steps, blocks, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. For example, those skilled in the art will appreciate that the logic sense (logic high (1), logic low (0)) of the apparatus and methods described herein may be reversed and still achieve equivalent results. The embodiment was chosen and described in order to best explain the principles of the invention and the practical application, and to enable others of ordinary skill in the art to understand the invention for various embodiments with various modifications as are suited to the particular use contemplated.

We claim:

1. A method, comprising:
receiving service requests by a plurality of middleware appliance information handling systems (MA IHSs) that communicate with a service domain, thus providing received service requests, each MA IHS including an entry point;
forwarding the received service requests, by the plurality of MA IHSs, to the service domain for handling, each MA IHS including a service level management component that forwards requests to the service domain based on a respective initial local traffic shaping rate goal;
determining, by the service level management component in each MA IHS, a traffic shaping rate and an actual traffic rate for each MA IHS;
exchanging, by the service level management component in each MA IHS, the traffic shaping rate and actual traffic rate of each MA IHS with the service level management components of the other MA IHSs, thus providing exchanged run time statistics;
determining, by the service level management component of each MA IHS, compliance with the initial traffic shaping rate goal of each MA IHS based on the traffic shaping rates and actual traffic rates of the exchanged run time statistics, thus providing respective compliance determinations; and
dynamically adjusting, by the service level management component of each MA IHS, the traffic shaping rate of each MA IHS in response to respective compliance determinations for each MA IHS.

2. The method of claim 1, further comprising:
increasing, by the service management component of a particular MA IHS, the traffic shaping rate of the particular MA IHS if the actual traffic rate for the particular MA IHS is less than a previous traffic shaping rate.

3. The method of claim 1, further comprising:
decreasing, by the service management component of a particular MA IHS, the traffic shaping rate of the particular MA IHS if the actual traffic rate for the particular MA IHS is greater than a previous traffic shaping rate.

4. The method of claim 1, wherein the determining of a traffic shaping rate and an actual traffic rate for each MA IHS is performed by the service level management component in each MA IHS during a measurement/enforcement time period.

5. The method of claim 4, measurement/enforcement time period includes a plurality of subintervals.

6. The method of claim 5, wherein the exchanging, by the service level management component in each MA IHS, of the traffic shaping rate and actual traffic rate of each MA IHS is performed at the end of each subinterval.

7. The method of claim 6, wherein the dynamically adjusting, by the service level management component of each MA IHS, of the traffic shaping rate of each MA IHS is performed at the end of each subinterval.
